(19) United States
(12) Patent Application Publication
(10) Pub. No.: US 2007/0146359 A1
(43) Pub. Date: Jun. 28, 2007

(54) CAD apparatus, CAD method and recording medium storing CAD program thereof

(75) Inventor: Tadatsugu Togawa, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/406,283

(22) Filed: Apr. 19, 2006

(30) Foreign Application Priority Data
Dec. 27, 2005 (JP) 2005-376512

(51) Int. Cl. G06T 15/00

(52) U.S. Cl. 345/419

(57) ABSTRACT

In order to create an appropriate two-dimensional extent so as not to be larger than necessary, for each figure of an object to be designed, a new coordinate system (a relative coordinate system) different from an originally employed global coordinate system is employed for creating a two-dimensional extent. Since a diagonal is longest in a two-dimensional extent, the relative coordinate system is created so that a longest portion of the figure is almost parallel to a diagonal of an extent of the figure. An extent of the figure is acquired on the basis of the relative coordinate system.

### BACKGROUND OF THE INVENTION

1. Field of the Invention

The present invention relates to a computer-aided design (CAD) apparatus, in particular to a CAD apparatus that creates an appropriate two-dimensional extent.

2. Description of the Related Art

In CAD, a computer is used for designing buildings and manufactured products. In two-dimensional or three-dimensional CAD, a two-dimensional extent is employed when a figure or the like in a two-dimensional space such as a display screen or an output drawing is processed. On a displayed screen of a CAD apparatus, a unique two-dimensional coordinate system (a global coordinate system) is employed with a reference point set on the screen.

A two-dimensional extent of a figure of an object to be designed is a circumscribed-rectangular virtual-display frame in which, in a two-dimensional coordinate system, among coordinate values of constituent points forming the figure, the maximum and minimum values on each coordinate axis are acquired and a difference between both values is used as a side. A two-dimensional extent takes an assisting roll in processing of a figure of an object to be designed in the CAD. Constituent points consist of vertices and nodes of a figure of an object to be designed.

FIGS. 10A and 10B show examples of employing a two-dimensional extent in overlapping check. Broken lines in

FIGS. 10A and 10B indicate two-dimensional extents.

FIG. 10A shows a case of relocation. As shown in FIG. 10A, a character symbol string “AAA” overlaps a figure symbol of a cube that is a three-dimensional model, and character symbol strings “BBB” and “CCC” overlap each other. In such a case, it is inevitable that two-dimensional extents of the three-dimensional model and the character symbol strings also overlap each other. Accordingly, by using a feature in which three-dimensional symbols do not overlap unless two-dimensional extents overlap, it is checked whether symbols such as figure symbols overlap each other. When a two-dimensional extent of a figure symbol or the like and two-dimensional extents of a plurality of character symbol strings overlap, the two-dimensional extents of the character symbol strings are relocated outside the two-dimensional extent of the figure or the like, and the two-dimensional extents of the character symbol strings are relocated so as not to overlap each other. FIG. 10B shows a case of element reduction.

In FIG. 10B, elements such as a straight line, a rectangle, an ellipse, and a triangle are allocated and each element has a two-dimensional extent. As for elements themselves, the straight line and the rectangle partly intersect each other, and the ellipse and the triangle do not intersect any other figures. As for the two-dimensional extents, the extent of the triangle does not intersect any other extents, and the extent of the rectangle intersects the extent of the ellipse and the extent of the straight line with which the elements themselves intersect each other. When points of intersection of elements are calculated, two-dimensional extents of the elements are checked for overlapping at first, so as to reduce the number of elements to be calculated for intersection. As a result, the triangle is omitted in the case of FIG. 10B.

Conventionally, in cases described above, two-dimensional extents based on the global coordinate system are employed.

Japanese Unexamined Patent Application Publication No. 61-138375 discloses a graphics processing apparatus which serves as the related art of the present invention.

### SUMMARY OF THE INVENTION

Two-dimensional extents based on a global coordinate system may be created to be larger than necessary. FIG. 11 shows a case of relocation in which a two-dimensional extent larger than necessary is created. Broken lines in FIG. 11 indicate two-dimensional extents. FIG. 11 has a long object as a three-dimensional model and a character symbol string “ABC” which overlaps the long object. The character symbol string needs to be displayed so as not to overlap the long object. Since the extent of the long object is created to be larger than necessary, by relocating the extent of the character symbol string so as not to overlap the extent of the long object, an unnecessary space indicated by the shaded area is generated as shown in FIG. 11.

In addition, in the case of acquiring points of intersection of elements; if the two-dimensional extents of the rectangle and the ellipse intersect each other as shown in FIG. 10B, it is determined that the rectangle and the ellipse are subject to be calculated for acquisition of points of intersection, even if the elements themselves do not intersect each other. Therefore, the larger a two-dimensional extent of an element, the worse the efficiency of processing.

The present invention has been made in order to solve the above problem. It is an object of the present invention to provide a method for creating smaller two-dimensional extent.

In the present invention, in order to avoid the problem caused by creating a two-dimensional extent in a global coordinate system, a different coordinate system (a relative coordinate system) is employed for creating a two-dimensional extent of a figure of each object to be designed. FIGS. 1A and 1B show examples of two-dimensional extents. Broken lines in FIGS. 1A and 1B indicate two-dimensional extents. FIG. 1A shows a two-dimensional extent of a figure of an object in a global coordinate system and FIG. 1B shows a two-dimensional extent of the same figure in a relative coordinate system. Details of present invention are described below.

A CAD apparatus according to an aspect of the present invention includes means for acquiring two end points which are farthest from each other from among constituent points of a figure of an object, means for acquiring a first point which is farthest from a straight line segment which connects the two end points from among the constituent points of the figure, means for acquiring a second point which is nearest to the first point among points of intersection between a circle which passes through the two end points and has the straight line segment as a diameter and a straight line which passes through the first point and is perpendicular to the straight line segment, means for creating a second coordinate system which has two vectors from the second point to the two end points respectively as coordinate axes, and means for creating a second two-dimensional extent of the figure in the second coordinate system. As described above, in the present invention, an extent is created so that its diagonal is almost parallel to a straight line formed by two farthest points among constituent points forming a figure projected in a two-dimensional space. A length of a diagonal of an extent is larger than any other straight line segment in the extent. Thus, a two-dimensional extent having a smaller area is expected to be acquired. In addition, in relocation of a figure of an object to be designed, an unnecessary space caused by a larger extent can be eliminated. Furthermore, in acquiring a point of intersection, such a condition can be reduced, where elements themselves don't intersect each other but their extents intersect each other.

The CAD apparatus may include means for creating a first two-dimensional extent of the figure in the first coordinate system which is originally employed, means for calculating a first area of the first two-dimensional extent, means for calculating a second area of the second two-dimensional extent, and means for choosing a smaller two-dimensional extent which has a smaller area between the first two-dimensional extent and the second two-dimensional extent. Since there is also a case in which a two-dimensional extent in a global coordinate system is smaller in area, by comparing the areas of the both two-dimensional extents created in the global coordinate system and a relative coordinate system and by choosing the smaller extent, an appropriate extent can be created as described above.

A computer-readable storage medium according to another aspect of the present invention stores a CAD program that allows a computer to execute a step of acquiring two end points which are farthest from each other from among constituent points of a figure of an object, a step of acquiring a first point which is farthest from a straight line segment which connects the two end points from among the constituent points of the figure, a step of acquiring a second point which is nearest to the first point among points of intersection between a circle which passes through the two end points and has the straight line segment as a diameter and a straight line which passes through the first point and is perpendicular to the straight line segment, a step of creating a second coordinate system which has two vectors from the second point to the two end points respectively as coordinate axes, and a step of creating a second two-dimensional extent of the figure in the second coordinate system.

The CAD program stored in the storage medium may allow the computer to execute a step of creating a first two-dimensional extent of the figure in the first coordinate system which is originally employed, a step of calculating a first area of the first two-dimensional extent, a step of calculating a second area of the second two-dimensional extent, and a step of choosing a smaller two-dimensional extent which has a smaller area between the first two-dimensional extent and the second two-dimensional extent.

A CAD method according to another aspect of the present invention allows a computer to execute a step of acquiring two end points which are farthest from each other from among constituent points of a figure of an object, a step of acquiring a first point which is farthest from a straight line segment which connects the two end points from among the constituent points of the figure, a step of acquiring a second point which is nearest to the first point among points of intersection between a circle which passes through the two end points and has the straight line segment as a diameter and a straight line which passes through the first point and is perpendicular to the straight line segment, a step of creating a second coordinate system which has two vectors from the second point to the two end points respectively as coordinate axes, and a step of creating a second two-dimensional extent of the figure in the second coordinate system.

The CAD method may allow the computer to execute a step of creating a first two-dimensional extent of the figure in the first coordinate system which is originally employed, a step of calculating a first area of the first two-dimensional extent, a step of calculating a second area of the second two-dimensional extent, and a step of choosing a smaller two-dimensional extent which has a smaller area between the first two-dimensional extent and the second two-dimensional extent.

The above summary of the present invention is not a description of features that are essential for the present invention. The present invention can include sub-combinations of the features.

### BRIEF DESCRIPTION OF THE DRAWINGS

FIGS. 1A and 1B show examples of two-dimensional extents;

FIG. 2 is a block diagram showing an example of a CAD apparatus according to an embodiment of the present invention;

FIG. 3 is a block diagram showing creation of an appropriate two-dimensional extent in an embodiment of the present invention;

FIG. 4 is a flowchart showing creation of an appropriate two-dimensional extent in an embodiment of the present invention;

FIG. 5 shows an example of two farthest end points and a farthest point in an embodiment of the present invention;

FIGS. 6A, 6B, 7A and 7B are illustrations of processes in which an origin of a relative coordinate system is acquired in an embodiment of the present invention;

FIGS. 8A and 8B are illustrations of examples of a relative coordinate system in an embodiment of the present invention;

FIG. 9 is an illustration of a relative coordinate system in an embodiment of the present invention;

FIGS. 10A and 10B show examples of employing a two-dimensional extent in overlapping check; and

FIG. 11 shows a case of relocation in which a two-dimensional extent larger than necessary is created.

FIG. 12 shows a typical computer environment.

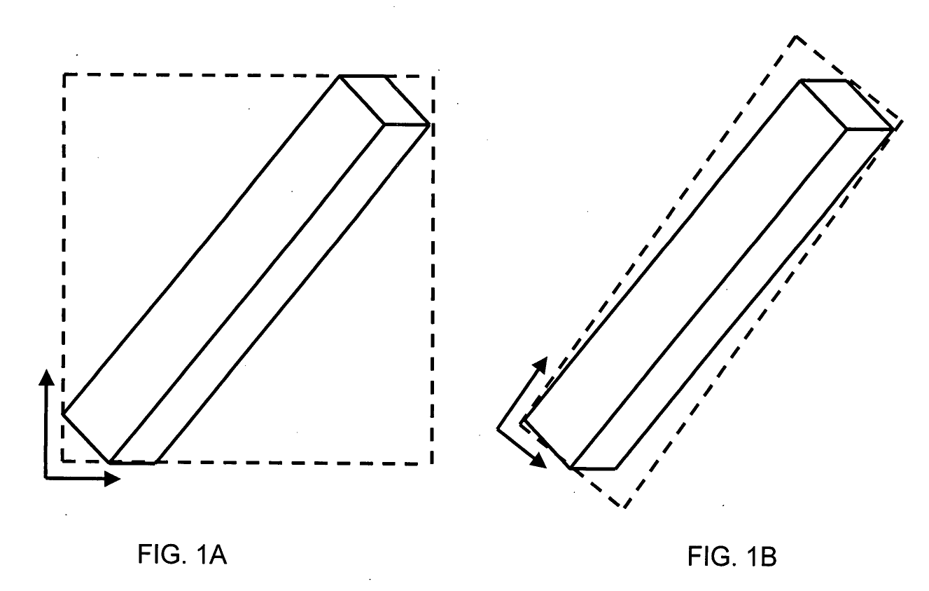

### DESCRIPTION OF THE PREFERRED EMBODIMENTS

The present invention can be practiced in many different forms. Therefore, the present invention should not be interpreted only on the basis of following description of embodiments of the present invention.

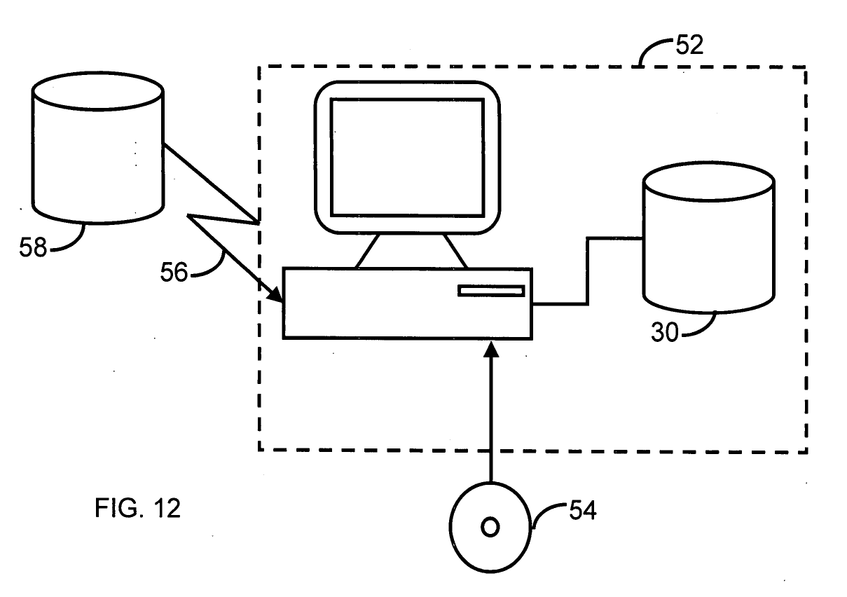

In the embodiment, an apparatus is mainly described. However, the present invention can be practiced in the form of a program usable on a computer, as is obvious to so-called “persons skilled in the art”. Also, the present invention can be practiced in an embodiment of hardware, an embodiment of software, and an embodiment of software and hardware. As shown in FIG. 12, the program for realizing the CAD apparatus may be stored in not only a portable recording medium 54 (e.g., compact disc read-only memory (CD-ROM), a CD-rewritable (CD-RW), a digital versatile disc recordable (DVD-R), a DVD random access memory (DVD-RAM), and a DVD-rewritable (DVD-RW)) but also a storage device 58 connected to a communication line 56, and a storage device/recording medium 60 (e.g., a hard disk and RAM) in a computer system 52. For executing the program, the program is loaded and executed in a main memory.

A CAD apparatus according to an embodiment of the present invention is described below with reference to the accompanying drawings. The CAD apparatus is intended for creating a two-dimensional extent of a figure of each object to be designed. The apparatus can exist alone as a CAD apparatus or a program, and can also be implemented as a program for providing a part of functions of known normal CAD programs with which, in a virtual two-dimensional coordinate space, a user draws and edits a shape of an object having a length and a width. In this embodiment, the case of the CAD apparatus is described below.

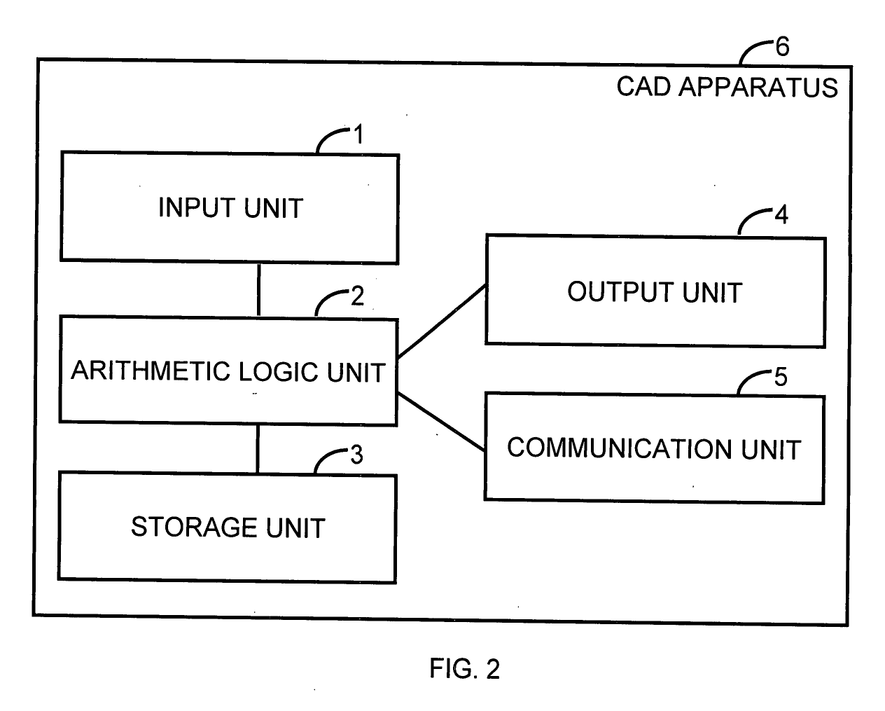

FIG. 2 is a block diagram showing an example of a CAD apparatus according to an embodiment of the present invention. This apparatus can be configured as a CAD apparatus 6 realized on a computer including an input unit 1 such as a keyboard or a mouse, an arithmetic logic unit 2 such as a central processing unit (CPU), a storage unit such as a hard disk or a main memory, an output unit such as a display device, and a communication unit 5 such as a LAN (local area network) card.

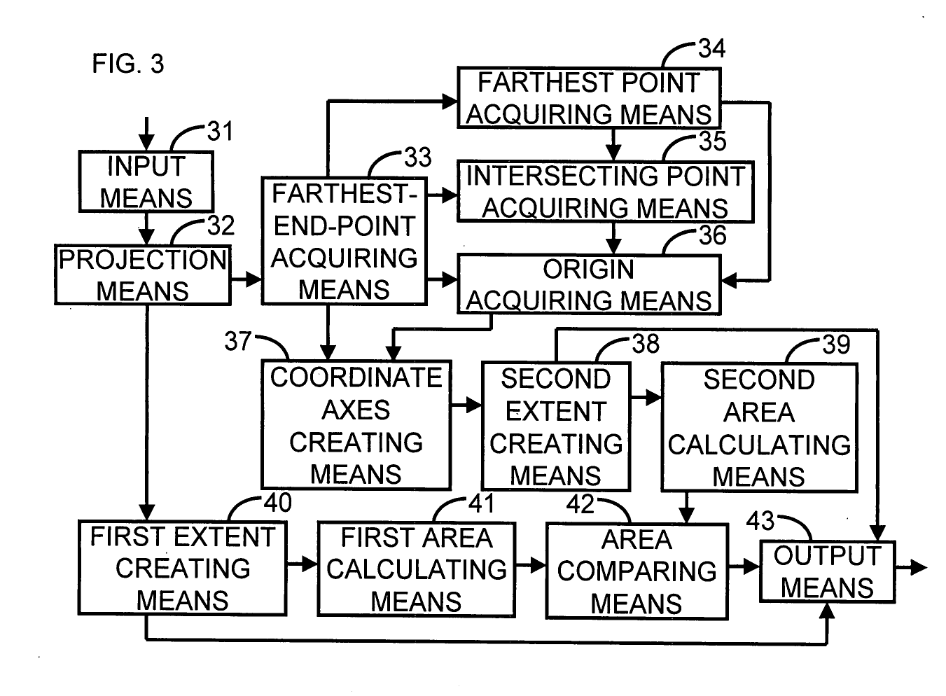

FIG. 3 is a block diagram showing creation of an appropriate two-dimensional extent in accordance with an embodiment of the present invention.

An input means 31 performs processing for inputting data of an object to be designed and sends the input data to a projection means 32.

The projection means 32 performs processing for projecting the data of the object onto a two-dimensional plane based on a global coordinate system and sends the result to a farthest-end-point acquiring means 33 and a first extent creating means 40.

The farthest-end-point acquiring means 33 performs processing for acquiring two end points that are farthest each other from among constituent points forming the figure of the object projected in the two-dimensional plane and sends data of the two end points to a farthest point acquiring means 34, a intersecting point acquiring means 35, an origin acquiring means 36 and a coordinate axes creating means 37.

The farthest point acquiring means 34 performs processing for acquiring a farthest constituent point which is farthest from a straight line segment which connects the two end points and sends data of the farthest constituent point to the intersecting point acquiring means 35 and the origin acquiring means 36.

The intersecting point acquiring means 35 performs processing for acquiring a point of intersection between the straight line segment and its perpendicular which passes through the farthest constituent point and sends data of the point of intersection to the origin acquiring means 36.

The origin acquiring means 36 performs processing for acquiring an origin of a relative coordinate system and sends data of the origin to the coordinate axes creating means 37.

The coordinate axes creating means 37 performs processing for creating coordinate axes of the relative coordinate system and sends data of the coordinate axes to a second extent creating means 38.

The second extent creating means 38 performs processing for creating a two-dimensional extent in the relative coordinate system and sends data of the two-dimensional extent in the relative coordinate system to a second area calculating means 39 and an output means 43.

The second area calculating means 39 performs processing for calculating an area of the two-dimensional extent in the relative coordinate system and sends data of the area of the two-dimensional extent in the relative coordinate system to an area comparing means 42.

The first extent creating means 40 performs processing for creating a two-dimensional extent in the global coordinate system and sends data of the two-dimensional extent in the global coordinate system to a first area calculating means 41 and an output means 43.

The first area calculating means 41 performs processing for calculating an area of the two-dimensional extent in the global coordinate system and sends data of the area of the two-dimensional extent in the global coordinate system to the area comparing means 42.

The area comparing means 42 performs processing for comparing the area of the two-dimensional extent in the relative coordinate system and the area of the two-dimensional extent in the global coordinate system and sends data of one of the two-dimensional extents which has smaller area to the output means 43.

The output means 43 performs processing for outputting the data of the two-dimensional extent which has smaller area.

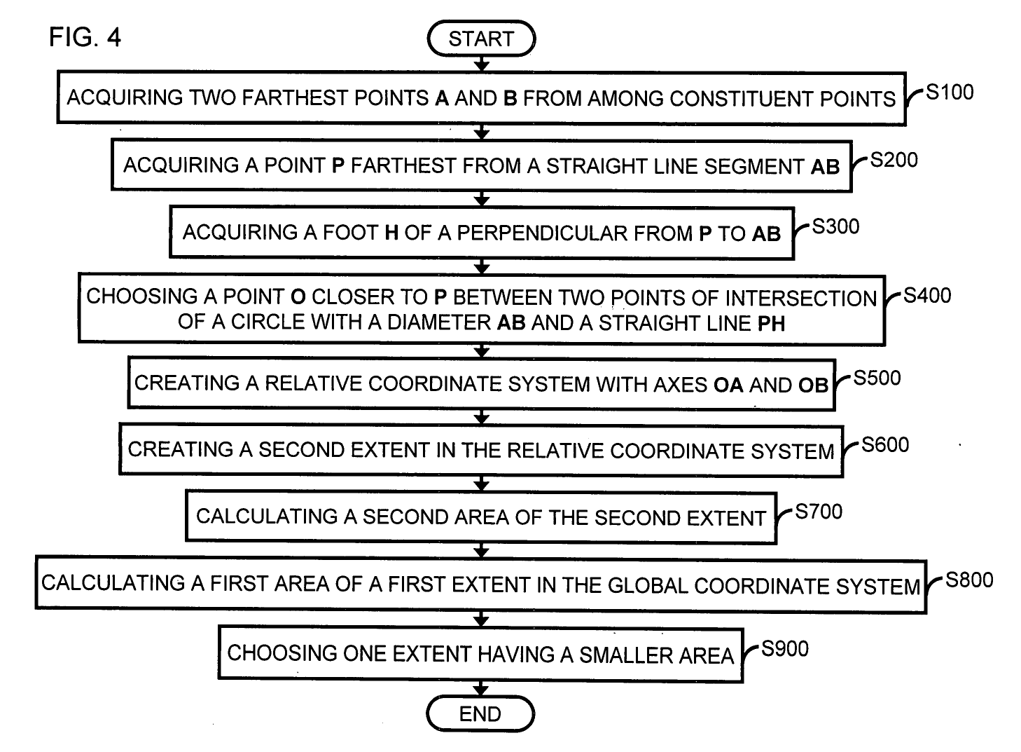

FIG. 4 is a flowchart showing creation of an appropriate two-dimensional extent in the embodiment of the present invention. The flowchart shows a process in the present invention including, after data of an object to be designed is projected in a two-dimensional plane, acquiring two farthest points A and B from among constituent points which form a figure of a projected element (step S100), acquiring a point P which is farthest from a straight line segment AB (step S200), acquiring a foot H of a perpendicular from the point P to the straight line segment AB (step S300), choosing a point O of intersection which is closer to the point P between two points of intersection which are formed by a circle whose diameter consists of the straight line segment AB and the straight line PH (step S400), creating a relative coordinate system in which vectors OA and OB are employed as two axes (step S500), creating a second two-dimensional extent on the basis of the relative coordinate system (step S600), calculating a second area of the second two-dimensional extent (step S700), calculating an first area of a first two-dimensional extent on the basis of the global coordinate system (step S800), and choosing one extent which has a smaller area between the first area and the second area as an appropriate extent (step S900). The process is described below.

After data of an object to be designed is input by the input unit 1, the data is stored in or retrieved from the storage unit 3 and is processed by the arithmetic logic unit 2. The arithmetic logic unit 2 projects the data onto a two-dimensional plane in order to display a three-dimensional structure of mainly a figure or the like, in a global coordinate system. The output unit 4 displays the projected data. The data of the object to be designed includes a three-dimensional model and an annotation. The three-dimensional model includes a wire frame model (including a circle and a curve) represented only by points and edges, a surface model represented by edges and planes, and a solid model having features and sets of primitives. The annotation includes a symbol, a finish mark, a note, a comment, a dimension, and a tolerance. A figure of a projected object has a large number of constituent points. Two end points A and B that are farthest each other among the constituent points are acquired by the arithmetic logic unit 2 (step S100). The arithmetic logic unit 2 performs the process by reading differences of coordinates of the constituent points represented in the global coordinate system.

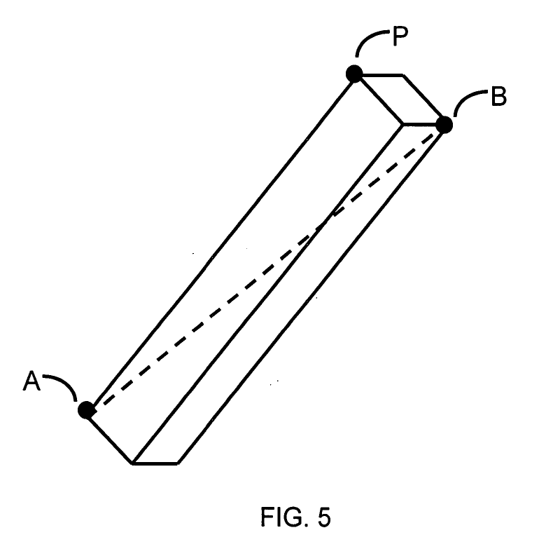

FIG. 5 shows an example of two farthest end points and a farthest point in an embodiment of the present invention. The object to be designed, shown in FIG. 5, is a long object, and points A and B are two farthest end points of the long object. The broken line indicates a straight line segment connecting the two farthest end points A and B. A point P is one of the constituent points of the long object. After creating a straight line segment AB by connecting the two farthest end points A and B, the arithmetic logic unit 2 acquires a farthest point P from among the constituent points of the long object, which is farthest from the straight line segment AB (step S200).

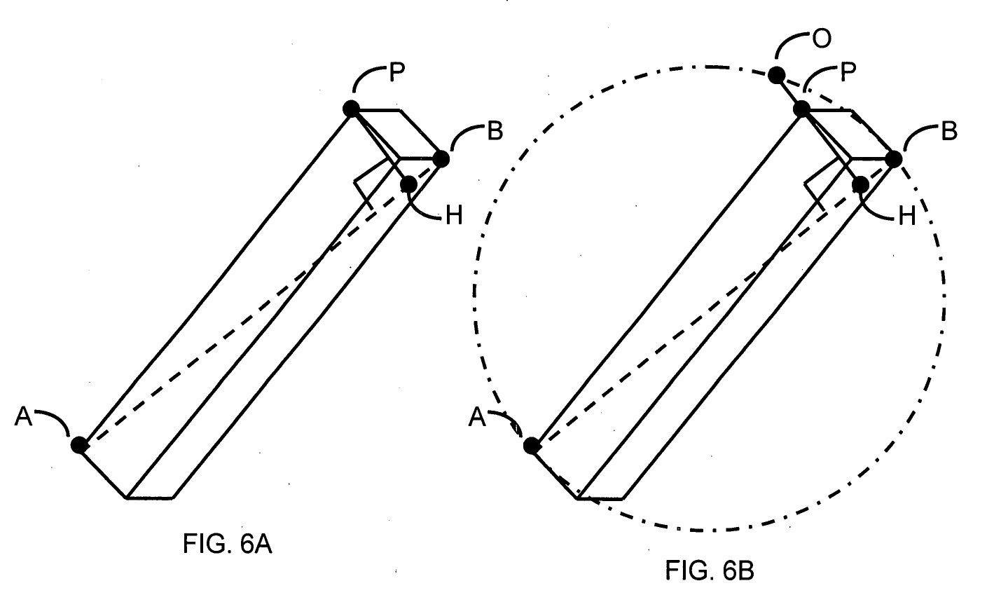

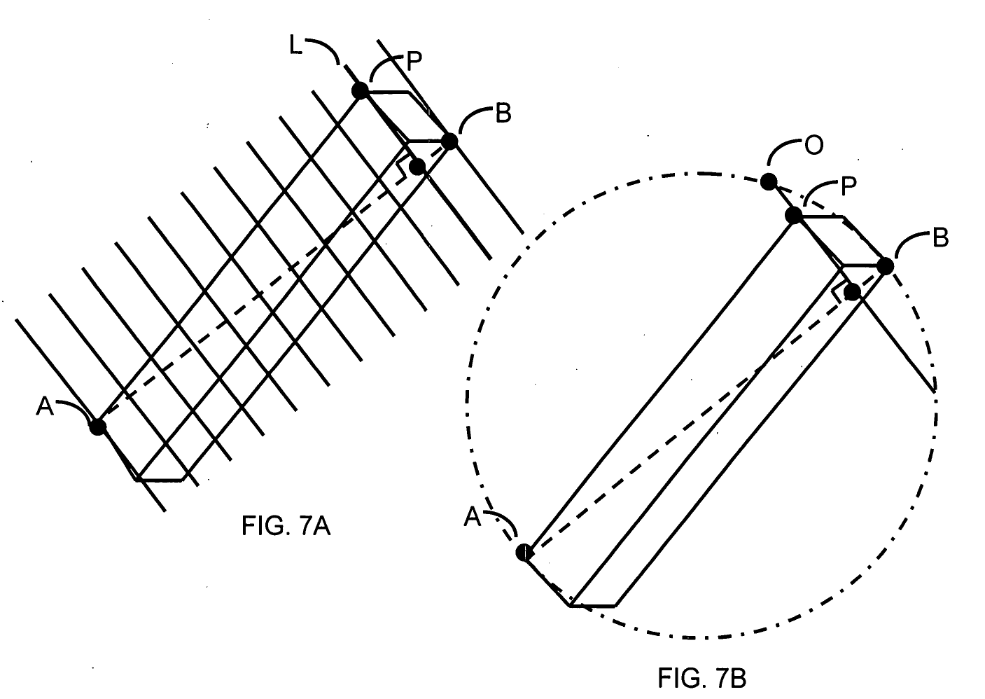

FIGS. 6A, 6B, 7A, and 7B show processes for acquiring an origin of a relative coordinate system.

FIG. 6A shows a process for acquiring a point of intersection between the straight line segment that connects the two farthest end points and a perpendicular from the farthest point to the straight line segment. After acquiring the constituent point P of the long object, the arithmetic logic unit 2 draws a perpendicular from the point P to the straight line segment AB, and acquires a point H that is a point of intersection between the perpendicular and the straight line segment AB (step S300).

FIG. 6B shows a process in which, after drawing a circle whose diameter is the straight line segment connecting the two farthest end points, the point of intersection acquired in the process shown in FIG. 6A is employed to acquire an origin of a relative coordinate system. As shown in FIG. 6B, the arithmetic logic unit 2 creates a circle whose diameter is the straight line segment AB. A dashed dotted line in FIG. 6B indicates the circle. The arithmetic logic unit 2 chooses a point O which is closer to the point. P between two points of intersection formed by the circle and a straight line passing through the point P and the point H (step S400). This point O serves as an origin of a relative coordinate system created for the long object.

The point O can be acquired by another process shown in FIGS. 7A and 7B. The process in FIGS. 7A and 7B is described below. Perpendiculars to a straight line segment connecting between the two farthest end points are drawn at a fixed pitch and one of the perpendiculars is selected which is the closest to the farthest point from the straight line segment. As shown in FIG. 7A, after acquiring the constituent point P of the long object, the arithmetic logic unit 2 draws perpendiculars at a fixed pitch with respect to the straight line segment AB connecting the two farthest end points A and B, and selects one of the perpendiculars which is the closest to the point P as a perpendicular L. After drawing a circle whose diameter is the straight line segment, from among points of intersection between the circle and the perpendicular selected in the step explained in FIG. 7A, a point of intersection is selected which is closest to the farthest point which is farthest from the straight line segment connecting the two farthest end points. As shown in FIG. 7B, the arithmetic logic unit 2 creates a circle whose diameter is the straight line segment AB. A dashed dotted line in FIG. 7B indicates the circle. The arithmetic logic unit 2 chooses one point which is the closest to the point P between two points of intersection formed by perpendicular L and the circle. The point chosen serves as an origin O.

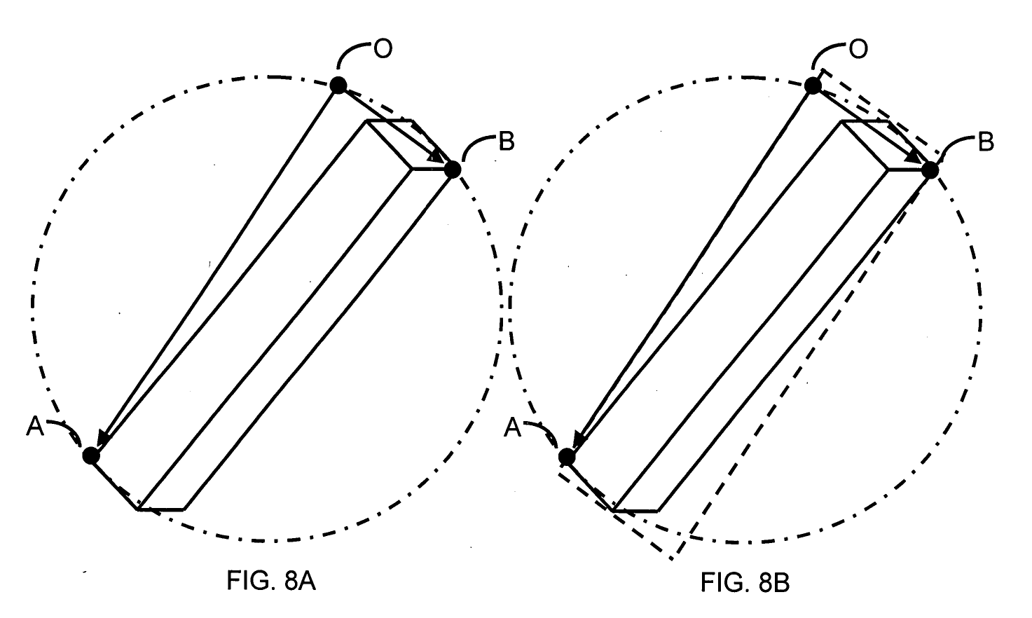

FIGS. 8A and 8B show an example of a relative coordinate system for each figure of objects to be designed. Broken lines in FIG. 8B indicate a two-dimensional extent. In FIG. 8A, the arrows directed from the point O to the end points A and B respectively indicate vectors. After acquiring the origin O, the arithmetic logic unit 2 creates a coordinate system in which vector OA extending from the origin O in the direction of the end point A and vector OB extending from the origin O in the direction of the end point B are used as coordinate axes (step S500). All the constituent points of the figure of the long object are converted into coordinate values in the relative coordinate system by the arithmetic logic unit 2. As shown in FIG. 8B, the arithmetic logic unit 2 acquires the maximum and minimum coordinate values on each coordinate axis in the relative coordinate system from all the coordinate values of all the constituent points of the figure of the long object, and creates a circumscribed-rectangular two-dimensional extent which has a difference between the maximum and minimum values as a side (step S600).

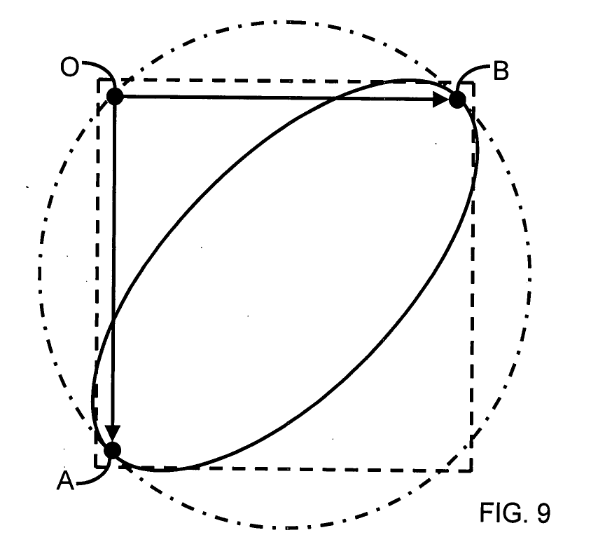

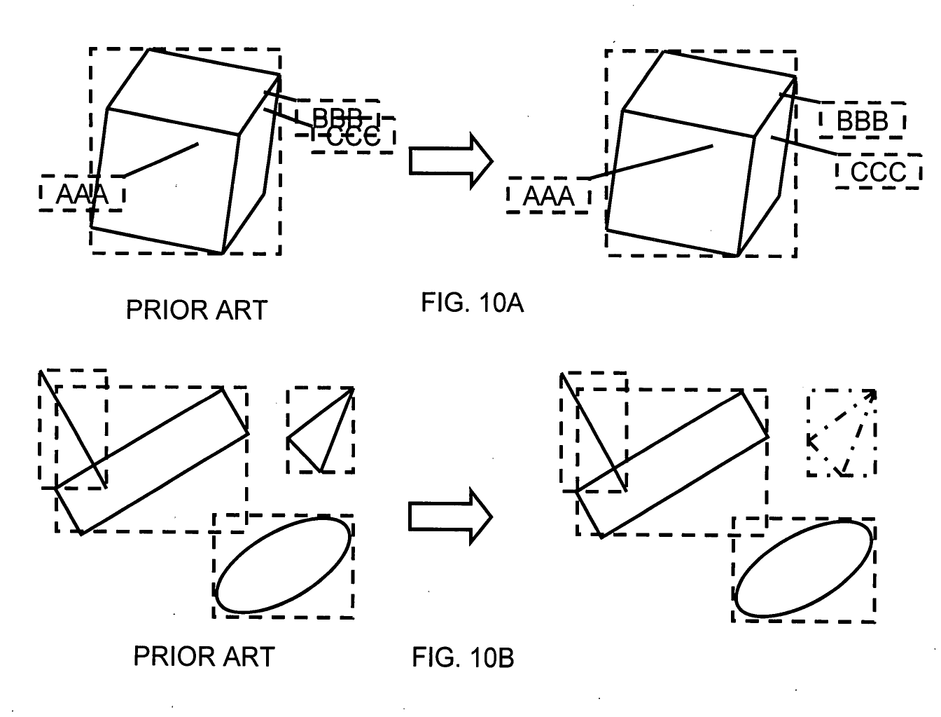

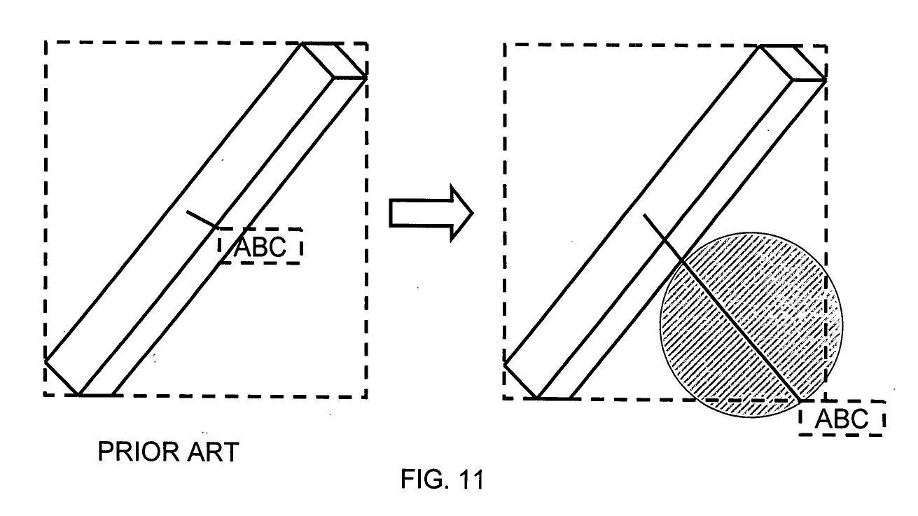

FIG. 9 shows an example of a relative coordinate system in a case in which a figure projected on a two-dimensional plane is an ellipse. Although the process up to creation of coordinate axes OA and OB is identical to that in the case of the long object in FIGS. 8A and 8B, the following processing is required since the ellipse is formed of a curve, while the long object consists of only straight lines. A curve forming an element is converted into a chain of lines (polyline), so that the polyline, instead of the curve, forms the element. By employing points of connection of lines in the polyline as constituent points, the maximum and minimum coordinate values on each coordinate axis in the relative coordinate system can be acquired. Next, a two-dimensional extent is created on the basis of the maximum and minimum values of coordinate OA, and the maximum and minimum values of coordinate OB. In FIG. 9, broken lines indicate a two-dimensional extent. The technique that converts a curve into a polyline is not a substantial part of the present invention. Various types of conversion exist as known technology and persons skilled in the art can employ various types of the known technology. Accordingly, a detailed description of the technique is omitted. Although an example of an ellipse has been described here, it is obvious that a two-dimensional extent of a figure which has another type of curve can be created by performing conversion of a curve into a polyline. This can apply to a figure consisting of curves and straight lines.

The arithmetic logic unit 2 calculates an area of a two-dimensional extent in a relative coordinate system (step S700). The area of the two-dimensional extent in the relative coordinate system can be acquired by calculating a length and a width of a circumscribed rectangle on the basis of coordinates of its vertices.

The arithmetic logic unit 2 calculates an area of a two-dimensional extent in a global coordinate system (step S800). A process for calculating the area of the two-dimensional extent in the global coordinate system is similar to that for acquiring the area of the two-dimensional extent in the relative coordinate system.

The arithmetic logic unit 2 compares the area of the two-dimensional extent in the relative coordinate system and the area of the two-dimensional extent in the global coordinate system, chooses one extent which has smaller area between both areas, and sends data of chosen extent to the output unit 4 (step S900). For example, when the rectangle is displayed at an inclination of zero degrees, the area of the two-dimensional extent in the global coordinate system is smaller than the area of the two-dimensional extent in the relative coordinate system. Thus, an appropriate two-dimensional extent can be acquired by employing the comparing process as described above.

Some variations of this embodiment are described as follows.

Displaying Two-dimensional Extent in Relative Coordinate System

In this embodiment, as for lines of a two-dimensional extent created in a relative coordinate system, line type such as color, thickness, etc. may be changed. A rectangular field of the two-dimensional extent may also be colored.

Simultaneously Displaying Two-dimensional Extents

In this embodiment, both two types of two-dimensional extents, one created in a global coordinate system and another created in a relative coordinate system, may be displayed together on a screen of the output unit 4.

Arbitrarily choosing Two-dimensional Extent

In this embodiment, one of two-dimensional extents, one created in a global coordinate system and another created in a relative coordinate system, may arbitrarily be chosen, if needed.

Correlation Between a Primitive and each Coordinate System

In this embodiment, on the basis of the result of choosing an appropriate two-dimensional extent of a figure of an object to be designed, data of correlation between a primitive and each coordinate system may be derived. The data of correlations can be reflected later in choosing an appropriate two-dimensional extent on the basis of model information and assembly information concerning an object to be designed. When a user arbitrarily chooses a two-dimensional extent, primitives come to have such choice tendencies that a two-dimensional extent created in the relative coordinate system is chosen for a certain primitive and a two-dimensional extent created in the global coordinate system is chosen for another primitive. User's convenience can greatly be improved such that the apparatus performs automatic choice based on the tendencies. In expanded form, it is preferable to assign a two-dimensional extent system for each primitive beforehand, and the user can switch two-dimensional extent systems for each primitive during use by the user. The primitives have been described on the assumption that a user draws figures with the primitives on a two-dimensional plane. Hence, when a three-dimensional model is projected on a two-dimensional plane, by determining which types of primitives constitute the figure of the projected object, the two-dimensional extent system assigned to each primitive may be employed in accordance with the result of the determination.

Although the present invention has been described by the above-described embodiments, the technical scope of the present invention is not limited to the described scope of the embodiments, and the embodiments may variously be altered or improved. The altered or improved embodiments are also included in the technical scope of the present invention. This is clearly understood from the appended Claims and the Summary of the Invention.

What is Claimed is:

1. Apparatus for computer aided design, said apparatus comprising:
means for acquiring two end points from among constituent points of a figure of an object, said two end points being farthest from each other among the constituent points;
means for acquiring a first point from among the constituent points of the figure, said first point being farthest from a straight line segment, said straight line segment connecting the two end points;
means for acquiring a second point from among points of intersection between a circle and a straight line, said circle passing through the two end points and having the straight line segment as a diameter, said straight line passing through the first point and being perpendicular to the straight line segment, said second point being nearest to the first point among the points of intersection between the circle and the straight line;
means for creating a second coordinate system having two vectors as coordinate axes, said two vectors being from the second point to the two end points respectively; and
means for creating a second two-dimensional extent in the second coordinate system, said second two-dimensional extent being of the figure.

2. The apparatus of claim 1, further comprising:
means for creating a first two-dimensional extent of the figure in a first coordinate system, said first coordinate system being originally employed;
means for calculating a first area of the first two-dimensional extent;
means for calculating a second area of the second two-dimensional extent; and
means for choosing a smaller two-dimensional extent between the first two-dimensional extent and the second two-dimensional extent, said smaller two-dimensional extent having a smaller area between the first area and the second area.

3. Program storage medium readable by a computer, tangibly embodying a program of instructions executable by the computer to perform method steps of computer aided design, said method comprising:
a step of acquiring two end points from among constituent points of a figure of an object, said two end points being farthest from each other among the constituent points;
a step of acquiring a first point from among the constituent points of the figure, said first point being farthest from a straight line segment, said straight line segment connecting the two end points;
a step of acquiring a second point from among points of intersection between a circle and a straight line, said circle passing through the two end points and having the straight line segment as a diameter, said straight line passing through the first point and being perpendicular to the straight line segment, said second point being nearest to the first point among the points of intersection between the circle and the straight line;
a step of creating a second coordinate system having two vectors as coordinate axes, said two vectors being from the second point to the two end points respectively; and
a step of creating a second two-dimensional extent in the second coordinate system, said second two-dimensional extent being of the figure.

4. The program storage medium of claim 3, said method further comprising:
a step of creating a first two-dimensional extent of the figure in a first coordinate system, said first coordinate system being originally employed;
a step of calculating a first area of the first two-dimensional extent;
a step of calculating a second area of the second two-dimensional extent; and
a step of choosing a smaller two-dimensional extent between the first two-dimensional extent and the second two-dimensional extent, said smaller two-dimensional extent having a smaller area between the first area and the second area.

5. Method capable of being carried out by an apparatus for computer aided design, said method comprising:
a step of acquiring two end points from among constituent points of a figure of an object, said two end points being farthest from each other among the constituent points;
a step of acquiring a first point from among the constituent points of the figure, said first point being farthest from a straight line segment, said straight line segment connecting the two end points;
a step of acquiring a second point from among points of intersection between a circle and a straight line, said circle passing through the two end points and having the straight line segment as a diameter, said straight line passing through the first point and being perpendicular to the straight line segment, said second point being nearest to the first point among the points of intersection between the circle and the straight line;
a step of creating a second coordinate system having two vectors as coordinate axes, said two vectors being from the second point to the two end points respectively; and
a step of creating a second two-dimensional extent in the second coordinate system, said second two-dimensional extent being of the figure.

6. The method of claim 5, further comprising:
a step of creating a first two-dimensional extent of the figure in a first coordinate system, said first coordinate system being originally employed;
a step of calculating a first area of the first two-dimensional extent;
a step of calculating a second area of the second two-dimensional extent; and
a step of choosing a smaller two-dimensional extent between the first two-dimensional extent and the second two-dimensional extent, said smaller two-dimensional extent having a smaller area between the first area and the second area.
